(19) United States
(12) Patent Application Publication
(10) Pub. No.: US 2024/0193950 A1
(43) Pub. Date: Jun. 13, 2024

(54) COMPUTER-IMPLEMENTED METHOD, SECURITY SYSTEM, VIDEO-SURVEILLANCE CAMERA, AND SERVER

(71) Applicant: AVA VIDEO SECURITY LIMITED, UXBRIDGE (GB)

(72) Inventor: HAOHAI SUN, NESBRU (NO)

(21) Appl. No.: 18/332,882

(22) Filed: Jun. 12, 2023

(30) Foreign Application Priority Data
Dec. 7, 2022 (GB) 2210238.8

(51) Int. Cl. G06V 20/52; G01S 15/04; G08B 21/00

(52) U.S. Cl. CPC G06V 20/52; G01S 15/04; G08B 21/00; G06V 2201/07

(57) ABSTRACT

A computer-implemented method of detecting the presence of a person and issuing an alert utilizing a security system comprising a video camera and a microphone. The computer-implemented method comprises: determining, by a video analyzer, whether a person is present within a field of view of the video camera from a video feed obtained from the video camera; determining, by an audio analyzer, whether a person is present within range of the microphone from one or more ultrasonic components extracted from an audio feed obtained from the microphone; and issuing an alert that a person has been detected by the security system when it has been determined by both the video analyzer and audio analyzer that a person is present.

### CROSS-REFERENCE TO RELATED APPLICATIONS

This application claims foreign priority to GB Application No. 2210238.8 filed Jul. 12, 2022, the entire contents of which are incorporated herein by reference in its entirety.

### BACKGROUND

In video security, video cameras are used to check if an unauthorized person is present in a building, room, office, etc. This can be, for example, when no one should be present in those areas (for example, outside of working hours, overnight, over a weekend, etc.). Increasingly this is done automatically by computer software.

However, video analytics-based person detection algorithms are prone to errors. For example, people walking outside of an office may trigger an alert of “person detected within the office” due to the video camera seeing through windows or glass walls. In addition, false positives can be detected for objects that resemble people.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 shows a schematic view of a security system in accordance with at least one example embodiment;

FIG. 2 is a flow diagram of a method in accordance with at least one example embodiment; and

FIG. 3 is a flow diagram of a variant method in accordance with at least one example embodiment.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In a first aspect, example embodiments provide a computer-implemented method of detecting the presence of a person and issuing an alert utilizing a security system that includes a video camera and a microphone. The computer-implemented method includes: (a) determining, by a video analyzer, whether a person is present within a field of view of the video camera from a video feed obtained from the video camera; (b) determining, by an audio analyzer, whether a person is present within range of the microphone from one or more ultrasonic components extracted from an audio feed obtained from the microphone; and (c) issuing an alert that a person has been detected by the security system when it has been determined by both the video analyzer and audio analyzer that a person is present.

It has been ascertained by the inventors that ultrasonic waves do not pass through walls and windows, and therefore the accuracy of indoor people detection by the security system is improved.

Optional features of example embodiments will now be set out. These are applicable singly or in any combination with any aspect of example embodiments.

The ultrasonic components of the audio feed may be extracted from the audio feed in one of: a time domain, or a time-frequency domain. The ultrasonic components may be extracted from the audio feed by application of a high pass filter to the audio feed obtained from the microphone. The ultrasonic components may be extracted from the audio feed by dividing the audio feed obtained from the microphone into a plurality of time-windows, transforming each time-window by use of a Fourier transform or filter bank into a plurality of frequency bins, and selecting one or more frequency bins which contain ultrasonic components.

The audio analyzer may apply a trained machine learning algorithm to the ultrasonic component(s) to determine whether a person is present within range of the microphone. For example, the machine learning algorithm may be a trained Neural Network (NN). The neural network may be trained such that the ultrasonic component(s) are provided to the NN, and the output of the NN indicates whether a person is present or not.

The training set, used to train the trained machine learning algorithm, may have included or may include recorded ultrasound signals emitted by indoor human activities, and many recorded ultrasound signals from other non-human events, background noises, or microphone self-noises. This training set has been or is fed to the neural network (for example, Deep NN (DNN), Convolutional NN (CNN)), and a supervised machine learning method is or has been applied. After some iterations, the neural network converged/updated or will converge/update to a state that fed or feeds the actual ultrasonic component(s) to the neural network, and therefore the output of the neural network indicates whether an indoor person is present or not.

The outputs of the neural network may be gathered within a period (for example, 10 s), voting may be used to make a final decision. This can skip some outliers and therefore reduce false alarms.

Step (b) may include a step of initially determining, by the audio analyzer and from the audio feed obtained from the microphone, whether a person is present within range of the microphone and then confirming this initial determination by determining from the ultrasonic component(s) whether the person is present. Determining from the ultrasonic component(s) whether a person is present may include comparing a level of the ultrasonic component(s) to a predetermined threshold. For example, the predetermined threshold may be indicative of a background level of ultrasonic sound (for example, from electronic devices, ventilation systems, and/or microphone self-noise). The initial determination may be performed by applying a trained machine learning model to the audio feed. Again, a NN may be trained such that by providing an audio feed as the input the output of the NN is an indication as to whether a person is present or not. Advantageously, this allows the more reliable determination as to the presence of a person as (typically) the sound detected is mostly in the audible frequency range (20 Hz to 16 kHz) where the signal to noise ratio is high.

Step (a) and step (b) may be performed sequentially in either order or in parallel.

No alert may be issued if only one of the video analyzer or audio analyzer determines that a person is present. The system may issue a first kind of alert when only one of the video analyzer or audio analyzer determines that a person is present, and may issue a second, different, kind of alert when both the video analyzer and audio analyzer determines that a person is present. The alert may be issued to a video management system.

The one or more ultrasonic components may have a frequency of at least 16 kHz, or at least 18 kHz, and no more than 22 kHz.

In a second aspect, example embodiments provide a security system that includes a video camera, configured to capture a video feed; a microphone, configured to capture an audio feed; a video analyzer, configured to obtain the video feed from the video camera and determine from the video feed whether a person is present within the video feed; an audio analyzer, configured to obtain the audio feed from the microphone and determine from one or more ultrasonic components extracted from the audio feed whether a person is present within range of the microphone; and an alert unit, configured to issue an alert that a person has been detected by the security system when it has been determined by both the video analyzer and audio analyzer that a person is present.

The security system of the second aspect may be configured to perform any one, or any combination insofar as they are compatible, of the optional features set out with reference to the method of the first aspect.

In a third aspect, example embodiments provide a video-surveillance camera, configured to capture a video feed. The video-surveillance camera includes a microphone, configured to capture an audio feed; a video analyzer, configured to obtain the video feed from the video-surveillance camera and determine from the video feed whether a person is present within the video feed; an audio analyzer, configured to obtain the audio feed from the microphone and determine from one or more ultrasonic components extracted from the audio feed whether a person is present within range of the microphone; and an alert unit, configured to issue an alert that a person has been detected by video-surveillance camera when it has been determined by both the video analyzer and audio analyzer that a person is present.

The video-surveillance camera of the third aspect may be configured to perform any one, or any combination insofar as they are compatible, of the optional features set out with reference to the method of the first aspect.

In a fourth aspect, example embodiments provide a server, the server being connectable over a network to a video camera and a microphone. The server includes a video analyzer, configured to obtain a video feed from the video camera and determine from the video feed whether a person is present within the video feed; an audio analyzer, configured to obtain an audio feed from the microphone and determine from one or more ultrasonic components extracted from the audio feed whether a person is present within range of the microphone; and an alert unit, configured to issue an alert that a person has been detected when it has been determined by both the video analyzer and audio analyzer that a person is present.

The server of the fourth aspect may be configured to perform any one, or any combination insofar as they are compatible, of the optional features set out with reference to the method of the first aspect. Example embodiments includes the combination of the aspects and preferred features described except where such a combination is clearly impermissible or expressly avoided.

Further aspects of example embodiments provide a computer program that includes code which, when run on a computer, causes the computer to perform the computer-implemented method of the first aspect; a computer readable medium storing a computer program that includes code which, when run on a computer, causes the computer to perform the computer-implemented method of the first aspect; and a computer system programmed to perform the computer-implemented method of the first aspect.

Each of the above-mentioned embodiments will be discussed in more detail below, starting with example system and device architectures of the system in which the embodiments may be practiced, followed by an illustration of processing blocks for achieving an improved technical method, device, and system for security and video surveillance.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented at least in part by computer program instructions. These computer program instructions may be provided to a processor of a general-purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

Referring now to the drawings, and in particular FIG. 1 shows a security system 100 at least partially installed within a room 106. The system includes one or more cameras 102, and one or more microphones 104A-D. The camera(s) and microphone(s) are, in this example, installed within a single unit 122. In some examples the camera(s) may be installed separately to the microphone(s). In the example shown in FIG. 1, the system includes one camera and four microphones.

The camera(s) and microphone(s) are connected to a video analyzer 116 and an audio analyzer 118. The video analyzer 116 is configured to determine that a person is present within a field of view of a video feed obtained from the or each camera. The audio analyzer 118 is configured to determine that a person is present within range of the microphone(s) from one or more ultrasonic components extracted from one or more audio feeds obtained from a respective microphone. The ultrasonic component can be extracted either in the time domain (for example, by applying a high pass filter to the regular sound signal), or in the short time-frequency domain (for example, by dividing the raw or regular signal into short time frames, transforming each frame to the frequency domain using a fast Fourier transform or filter bank, and then picking the frequency bins which contain ultrasonic signals).

In some examples, the video analyzer 116 and the audio analyzer 118 are a part of the unit for example, as software running on a processor therein or as part of an System On Chip (SOC). In such an example, the camera(s) and microphone(s) are directly connected to the processor. In other examples, the video and audio analyzer may be installed remotely to the camera and microphones for example, within a server connected to the camera(s) and microphone(s) via a network. The server may, for example, be a cloud server. The video analyzer and audio analyzer are also connected to an alert unit 120, the alert unit is configured to issue an alert that a person has been detected by the security system when it has been determined by both the video analyzer and the audio analyzer that a person is present. The alert may include, for example, a message and/or video clips from the camera(s). The video clips can contain, for example, frames in which the person was detected (and corresponding, temporally, to a time when the audio analyzer also determined a person to be present). In some examples, there may be a single video analyzer and a single audio analyzer each connected to all of or the camera(s) and microphone(s) respectively. In an alternative example, there may be a plurality of audio analyzers each connected to a respective microphone. In such examples, the alert unit may require that only one of the audio analyzers to determine that a person is present or may require a majority of the audio analyzers to determine that a person is present.

For example, a person 112 is outside of room 106. The room has a glass wall, and so the person 112 is within a field of view 124 of the camera, and so present in the video stream. The video analyzer 116 will therefore determine that a person is present and provide this determination to the alert unit 120. However, the ultrasonic components 114 of sound emitted by the person 112 will not be picked up by the microphone(s) 104A—104D due to the glass wall between the person and the camera. Therefore the audio analyzer 118 does not determine, based on ultrasonic components of the audio signal, the presence of the person 112. The failure to receive a determination from both the video analyzer and audio analyzer means that the alert unit will not trigger. There are several ways of implementing this mechanism: (a) both the video analyzer and audio analyzer determine, simultaneously, that a person is present; (b) the video analyzer determines that a person is present, and after this the audio analyzer determines within a predetermined time limit (for example, at least 20 ms, no more than 1 second, 2 seconds, 3 seconds, 4 seconds, or 5 seconds) that a person is present; (c) the audio analyzer determines that a person is present, and after this the video analyzer determines within a predetermined time limit (for example, at least 20 ms, no more than 1 second, 2 seconds, 3 seconds, 4 seconds, or 5 seconds) that a person is present; (d) the video analyzer determines that a person is present whilst the audio analyzer is disabled, the audio analyzer to then caused to determine whether a person is present when the video analyzer has determined that a person is present; (e) the audio analyzer determines that a person is present whilst the video analyzer is disabled, the video analyzer to then caused to determine whether a person is present when the audio analyzer has determined that a person is present. Options (d) and (e) have the advantage of reducing processing power.

In contrast, person 108 is within the room 106. As before, they are within a field of view 124 of the camera and so present in the video stream. The video analyzer 116 will therefore determine that a person is present and provide this determination to the alert unit 120. In this example, as the person 108 is within the room, the ultrasonic components 110 of sound emitted by the person 108 will be picked up by the microphone(s) 104A-104D. The audio analyzer 118 is therefore able to determine, based on the ultrasonic components of the audio signal, the presence of person 108. As the alert unit 120 will receive positive determinations from both the video analyzer 116 and audio analyzer 118, it will issue an alert that a person has been detected by the security system. This alert could, for example, go to a remote video management system or similar.

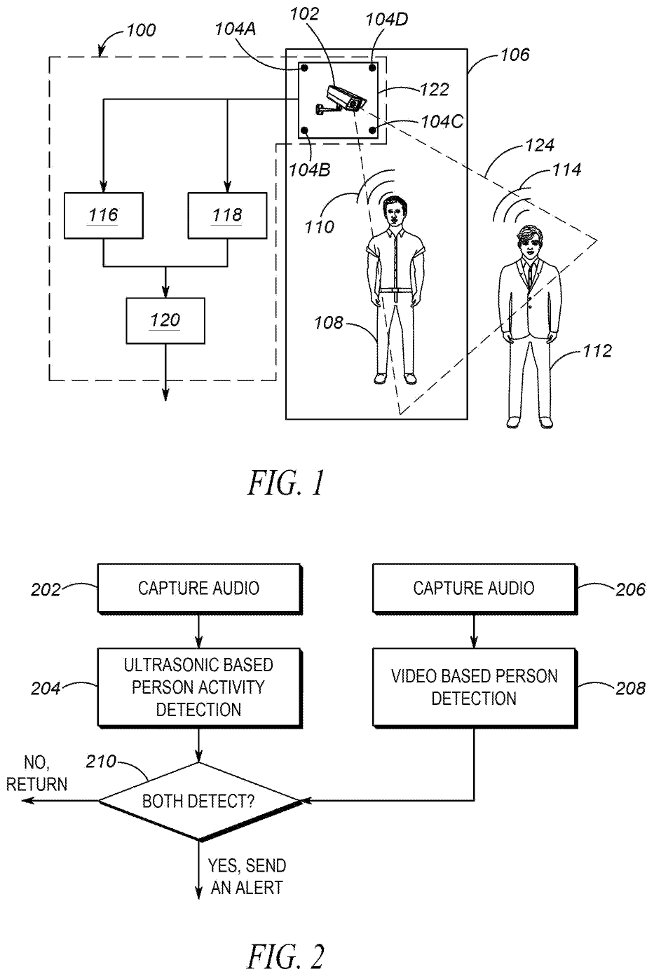

FIG. 2 is a flow diagram illustrating, in accordance with at least one example embodiment, the above described method. Audio is captured in step 202, and then ultrasonic based person activity detection is performed in step 204 based on the captured audio. Simultaneously, or before, or after, video is captured in step 206. Video based person detection is then performed in step 208 based on the captured video. The determinations from both steps 204 and 208 are used to determine, at step 210, whether a person has been detected by both the ultrasonic based person detection and the video based person detection. If so, ‘Yes’, an alert is issued. If not, ‘no’, the method returns and captures further audio and video for analysis. The step 204 may include an initial step of extracting one or more ultrasonic components of an audio feed or audio signal, which can be performed by the audio analyzer. Alternatively, the microphone may provide the ultrasonic components directly to the audio analyzer.

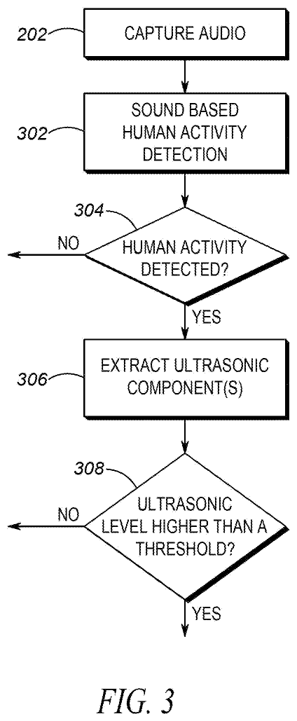

FIG. 3 is a flow diagram of a variant method, in accordance with at least one example embodiment, performed by the audio analyzer. The detection of a person by the audio analyzer can be performed in two stages. After capturing the audio in step 202, a sound based human activity detection step 302 is performed. This detection step utilizes the captured audio, including all frequency components thereof. The result of this is provided to step 304, where if human activity is not detected, ‘No’, the method returns to step 202, otherwise, ‘Yes’, the method proceed to step 306 where ultrasonic component(s) are extracted. Once the ultrasonic component(s) have been extracted, the method proceeds to step 308 where a determine is made as to whether the ultrasonic level is higher than a predetermined threshold (for example, the background noise level of the ultrasonic frequency range). If not, ‘No’, the method returns to step 202, otherwise, ‘Yes’, a determination is made that a person is present by the audio analyzer.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilized for realizing example embodiments in diverse forms thereof.

While the invention has been described in conjunction with the exemplary embodiments described above, many equivalent modifications and variations will be apparent to those skilled in the art when given this disclosure. Accordingly, example embodiments set forth above are considered to be illustrative and not limiting. Various changes to the described embodiments may be made. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (for example, a human mind cannot interface directly with RAM or other digital storage, cannot transmit or receive electronic messages, electronically encoded video, electronically encoded audio, etc., and cannot analyze ultrasonic components extracted from an audio feed to determine whether a person is present within a range of a microphone, among other features and functions set forth herein).

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (for example, comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The term “one of”, without a more limiting modifier such as “only one of”, and when applied herein to two or more subsequently defined options such as “one of A and B” should be construed to mean an existence of any one of the options in the list alone (for example, A alone or B alone) or any combination of two or more of the options in the list (for example, A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method of detecting the presence of a person and issuing an alert, utilizing a security system comprising a video camera and a microphone, the computer-implemented method comprising:
determining, by a video analyzer, whether the person is present within a field of view of the video camera from a video feed obtained from the video camera;
determining, by an audio analyzer, whether the person is present within range of the microphone from one or more ultrasonic components extracted from an audio feed obtained from the microphone; and
issuing the alert, that the person has been detected by the security system, when it has been determined by both the video analyzer and the audio analyzer that the person is present.

2. The computer-implemented method of claim 1, wherein the ultrasonic component(s) of the audio feed are extracted from the audio feed in one of: a time domain; or a time-frequency domain.

3. The computer-implemented method of claim 2, wherein the ultrasonic component(s) are extracted from the audio feed by application of a high pass filter to the audio feed obtained from the microphone.

4. The computer-implemented method of claim 2, wherein the ultrasonic component(s) are extracted from the audio feed by dividing the audio feed obtained from the microphone into a plurality of time-windows, transforming each time-window by use of a Fourier transform or filter bank into a plurality of frequency bins, and selecting one or more frequency bins which contain ultrasonic components.

5. The computer-implemented method of claim 1, wherein the audio analyzer applies a trained machine learning model to the ultrasonic component(s) to determine whether the person is present within range of the microphone.

6. The computer-implemented method of claim 1, wherein the determining by the audio analyzer includes initially determining, by the audio analyzer and from the audio feed obtained from the microphone, whether the person is present within range of the microphone, and then confirming this initial determination by determining from the ultrasonic component(s) whether the person is present.

7. The computer-implemented method of claim 6, wherein determining from the ultrasonic component(s) whether the person is present includes comparing a level of the ultrasonic component(s) to a predetermined threshold.

8. The computer-implemented method of claim 6, wherein the initial determination is performed by applying a trained machine learning model to the audio feed.

9. The computer-implemented method of claim 1, wherein no alert is issued if only one of the video analyzer or audio analyzer determines that the person is present.

10. The computer-implemented method of claim 1, wherein the alert is issued to a video management system.

11. The computer-implemented method of claim 1, wherein the one or more ultrasonic components have a frequency of at least 18 kHz and no more than 22 kHz.

12. Apparatus comprising:
a video camera, configured to capture a video feed;
a microphone, configured to capture an audio feed;
a video analyzer, configured to obtain the video feed from the video camera and determine from the video feed whether a person is present within the video feed; and
an audio analyzer, configured to obtain the audio feed from the microphone and determine from one or more ultrasonic components extracted from the audio feed whether the person is present within range of the microphone,
wherein an alert of the person being detected is issued, during operation of the apparatus, based on both the video analyzer and the audio analyzer having determined that the person is present.

13. The apparatus of claim 12, wherein the ultrasonic component(s) of the audio feed are extractable from the audio feed in one of: a time domain; or a time-frequency domain.

14. The apparatus of claim 13, wherein the ultrasonic component(s) are extractable from the audio feed by application of a high pass filter to the audio feed obtained from the microphone.

15. The apparatus of claim 12, wherein the audio analyzer is further configured to apply a trained machine learning model to the ultrasonic component(s) to determine whether the person is present within range of the microphone.

16. A server that is connectable over a network to a video camera and a microphone, and the server comprising:
at least one processor;
at least one non-transitory, computer readable medium, communicatively coupled to the at least one processor and storing code;
a video analyzer, configured to obtain a video feed from the video camera and determine from the video feed whether a person is present within the video feed; and
an audio analyzer, configured to obtain an audio feed from the microphone and determine from one or more ultrasonic components extracted from the audio feed whether the person is present within range of the microphone,
wherein the code is operable on the at least one processor to issue an alert that the person has been detected when it has been determined by both the video analyzer and the audio analyzer that a person is present.

17. The server of claim 16, wherein the ultrasonic component(s) of the audio feed are extractable from the audio feed in one of: a time domain; or a time-frequency domain.

18. The server of claim 17, wherein the ultrasonic component(s) are extractable from the audio feed by application of a high pass filter to the audio feed obtained from the microphone.

19. The server of claim 16, wherein the audio analyzer is further configured to apply a trained machine learning model to the ultrasonic component(s) to determine whether the person is present within range of the microphone.
